(19) United States
(12) Patent Application Publication
(10) Pub. No.: US 2024/0138403 A1
(43) Pub. Date: May 2, 2024

(54) Synergistic Combinations for Reducing Volatility of Auxin Herbicides

(71) Applicant: Ethox Chemicals, LLC, Greenville, SC (US)

(72) Inventors: John Hemminghaus, Greenville, SC (US); Willliam C. Floyd, III, Greenville, SC (US); Bradley M. Swillen, Greenville, SC (US)

(21) Appl. No.: 18/537,353

(22) Filed: Dec. 12, 2023

Related U.S. Application Data
(62) Division of application No. 17/854,392, filed on Jun. 30, 2022.
(60) Provisional application No. 63/216,595, filed on Jun. 30, 2021.

(51) Int. Cl. A01N 25/22; A01N 25/02; A01N 37/10; A01N 43/38; A01N 57/20

(52) U.S. Cl. CPC A01N 25/22; A01N 25/02; A01N 37/10; A01N 43/38; A01N 57/20

(57) ABSTRACT

Provided is an improved herbicide formulation and an improved method of treating a crop. The herbicide formulation comprises a herbicide and a volatility reduction adjuvant comprising a salt of a volatile acid and a salt of a nonvolatile acid.

### CROSS-REFERENCE TO RELATED APPLICATIONS

This application claims the priority of pending U.S. Provisional Patent Application No. 63/216,595 filed Jun. 30, 2021 which is incorporated herein by reference.

### FIELD OF THE INVENTION

The invention is related to an improved volatility reduction adjuvant which is particularly suitable for use with auxin herbicides and particularly when used as a tank adjuvant in a spray formulation.

### BACKGROUND

There is a continued demand to achieve the maximum crop yield per acre. This demand has led to an increase in various crop treatment formulations which are frequently applied as a spray. As land availability challenges increase, the frequency of adjacent incompatible crops becomes an ongoing challenge for farmers. This is particularly relevant when treating a crop with a spray formulation adjacent to a crop which is incompatible with the sprayed formulation. This dilemma has led to the necessity for reducing the off target movement from sprayed formulations thereby limiting the ability of a spray formulation to cause damage to adjacent, incompatible crops.

Yet another ongoing issue with modern farming is cost control. The ever-increasing demand to lower the cost of farming requires formulations with fewer, or lower concentrations, of additives. The desire to lower the number, and amount, of additives to a spray formulation is contrary to the desire to reduce off target movement.

The use of auxin herbicides has increased in recent years due to the rise of broadleaf weeds resistant to the typical in-crop herbicides such as glyphosate. While auxin herbicides are excellent for controlling these challenging weeds, such as waterhemp and palmer amaranth, they can cause symptomology and, in some cases, damage non-target crops at very low doses. This off-target symptomology has resulted in additional regulations being placed on the use of these herbicides, including spray cut off dates, and the use of a volatility reducing agent added as a tank adjuvant. One of the most common chemicals used as a volatility reducing agent is potassium acetate, which is less effective at low concentration.

There has been an ongoing desire for spray formulation additives capable of controlling both spray droplet size and auxin volatility in a tank mix while also decreasing the amount of additives utilized in the spray formulation. These desires are considered contrary to each other. The present invention provides a synergistic combination of components which improves the herbicide volatility control over existing technology and optionally provides droplet size control with lower total amount of additive required.

### SUMMARY OF THE INVENTION

The present invention is related to an improved volatility reduction adjuvant for treatment of crops, particularly spray treatment of crops.

A particular advantage of the instant invention is improved volatility control for reduced off target movement of a sprayed formulation.

A particular feature of the invention is the ability to utilize a lower total amount of adjuvant while achieving superior drift and herbicide volatility control properties.

These and other advantages, as will be realized, are provided in a herbicide formulation comprising a herbicide and a volatility reduction adjuvant comprising a salt of a volatile acid and a salt of a nonvolatile acid.

Another embodiment is provided in a method for treating a crop comprising: forming a spray formulation by combining a herbicide formulation with a volatility reduction adjuvant comprising:
a salt of a volatile acid; and
a salt of a nonvolatile acid.

### DESCRIPTION

The present invention is related to an improved volatility reduction adjuvant which is particularly suitable for use with herbicides and particularly auxin based herbicides or combinations of auxin with other herbicides. More specifically, the present invention is related to a synergistic combination of a salt of a volatile acid and a salt of a nonvolatile acid wherein the combination reduces herbicide volatility when added to a herbicide formulation, particularly as a tank addition to a spray formulation. It has been unexpectedly determined that the combination of these salts reduces herbicide volatility in a more efficient manner and at lower concentrations than using either volatile acid salts (ie, potassium acetate) or nonvolatile salts (i.e., potassium citrate) alone. This allows for an advantageous lower use rate. Furthermore, these salts can be combined in a single formula with additional adjuvants and components such as surfactants, water conditioning agents, and drift control agents, allowing for a single formula which replaces what have hitherto been multiple components which must be added separately.

The present invention provides a synergistic combination of a salt of a volatile acid and a salt of a non-volatile acid wherein the combination improves off target movement reduction, by reducing volatility, of herbicides and particularly auxin herbicides. The salt of a volatile acid is preferably a monocarboxylate salt and the salt of a non-volatile acid is preferably a polycarboxylate salt. It is unexpected that a nonvolatile carboxylate salt would boost the performance of a monocarboxylate, particularly acetate, based antivolatility agent.

It has now been surprisingly discovered that some of the chemicals which are effective as water conditioners are synergistic with potassium acetate, and when used at the proper ratio of potassium acetate, for example, to water conditioner the result is a greater reduction of herbicide volatility than expected. This synergy enables new volatility reduction adjuvants which require lower use rates, thus reducing the amount of material that a farmer needs to purchase and add to the spray tank to achieve the volatility targets set by the Environmental Protection Agency (EPA).

The present invention provides a specific combination of salts that act synergistically to provide a larger reduction in volatility compared to either salt alone. Specifically, combinations of potassium acetate, as a representative salt of a volatile acid, and potassium citrate, as a representative salt of a nonvolatile acid, at specific weight ratios of potassium acetate to potassium citrate has proven to provide unexpected and significant improvements in volatility control. The combination of potassium acetate and potassium citrate, as a non-limiting example, is more effective at reducing dicamba volatility than a higher rate of potassium acetate alone as evidenced by the amount of dicamba present in the headspace of humidomes over a 24 hour period.

For the purposes of the present invention a volatile acid is defined as a monocarboxylic acid having a vapor pressure of at least 1 mm Hg at 20° C. A salt of a volatile acid is the lithium, sodium, potassium, calcium, magnesium, zinc, copper, choline, monoethanolammonium, diethanolammonium, triethanolammonium, or other amine salt of a volatile acid. Preferred salts of volatile acids are salts of volatile acids selected from the group consisting of formic acid, carbonic acid, lactic acid, acetic acid, propionic acid, butyric acid, valeric acid and caproic acid. Preferred salts of volatile acids are selected from the group consisting of lithium formate, sodium formate, potassium formate, mono, di, or triethanolammonium formate, lithium carbonate, sodium carbonate, potassium carbonate, mono, di, or triethanolammonium carbonate, lithium bicarbonate, sodium bicarbonate, potassium bicarbonate, mono, di, or triethanolammonium bicarbonate, lithium acetate, sodium acetate, potassium acetate, mono, di, or triethanolammonium acetate, lithium propionate, sodium propionate, potassium propionate, mono, di, or triethanolammonium propionate, lithium butyrate, sodium butyrate, potassium butyrate, mono, di, or triethanolammonium butyrate, lithium valerate, sodium valerate, potassium valerate, mono, di, or triethanolammonium valerate, lithium caprylate, sodium caprylate, potassium caprylate and mono, di, or triethanolammonium caprylate. Acetate salts are particularly suitable monocarboxylate salts with potassium salts, sodium salts and amine salts being suitable for demonstration of the invention. Potassium acetate is particularly suitable for demonstration of the invention.

For the purposes of the present invention a nonvolatile acid is a polycarboxylic acid with no appreciable vapor pressure or a vapor pressure below 0.1 mm Hg at 20° C. A salt of a nonvolatile acid is a lithium, sodium, potassium, calcium, magnesium, zinc, copper, mono, di, or triethanolammonium, or other amine salt of a nonvolatile acid. Preferred salts of non-volatile are salts of nonvolatile acids selected from the group consisting of polycarboxylic acids, phosphates, tartrates, sulfates, oxalates, citrates, borates, carbonates, malonates, succinates, maleates, glutarates, polyacrylates, polymethacrylates, trimellitates, pyromellitates, phytates, or amino acids such as glycine, alanine, glutamic acid, etc. Particularly preferred salts of polycarboxylic acid are salts of dicarboxylic acids, tricarboxylic acids and polycarboxylic acids. The polycarboxylate salt can be a salt of a polyacrylate, polyphosphate or polycarbonate. A particularly preferred polycarboxylate salt is a diacid or tricarboxylate salt. Particularly preferred salts of polycarboxylic acid are salts of polycarboxylic acids selected from the group consisting of oxalic acid, malonic acid, malic acid, succinic acid, citric acid, maleic acid and tartaric acid. Particularly salts of polycarboxylic acid are selected from the group consisting of lithium oxalate, sodium oxalate, potassium oxalate, mono, di, or triethanolammonium oxalate, lithium malonate, sodium malonate, potassium malonate, mono, di, or triethanolammonium malonate, lithium malate, sodium malate, potassium malate, mono, di, or triethanolammonium malate, lithium succinate, sodium succinate, potassium succinate, mono, di, or triethanolammonium succinate, lithium citrate, sodium citrate, potassium citrate, mono, di, or triethanolammonium citrate, lithium maleate, sodium maleate, potassium maleate, mono, di, or triethanolammonium maleate, lithium tartrate, sodium tartrate, potassium tartrate and mono, di, or triethanolammonium tartrate. A particularly preferred salt of a nonvolatile acid is potassium citrate.

For the purposed of clarity the combination of a volatile acid, or salt thereof, and a nonvolatile acid, or salt thereof, are referred to collectively as a volatility reduction adjuvant. The volatility reduction adjuvant can be provided separately and added to a spray formulation diluted for use. Alternatively, the volatility reduction adjuvant can be added to an herbicide concentrate prior to dilution for use. In a particularly preferred embodiment, the volatility reduction adjuvant is provided independently of the herbicide formulation.

In an embodiment the volatility reduction adjuvant further comprises polyacrylamide, guar, or other drift control agents which function to reduce the amount of fine particles produced during application and provides an additional feature of drift control in a single product.

In an embodiment, the volatility reduction adjuvant provides further advantages such as water conditioning, which reduces or eliminates the negative effect of divalent and trivalent cations on herbicide efficacy. Additional additives such as defoamers, wetters, stickers, penetrants, and surfactants may also be used.

The weight ratio of salt of a volatile acid to salt of a nonvolatile acid in the volatility reduction adjuvant is preferably about 10:1 and 1:1, more preferably between 5:1 and 2:1 with about 3:1 being optimal.

A particularly suitable volatility reduction adjuvant is provided by a mixture of about 50-85% of a 50% solution of potassium acetate with the balance of the volatility reduction adjuvant being potassium citrate. Another particularly suitable volatility reduction adjuvant is provided by a mixture of about 60-80% of a 50% solution of potassium acetate with the balance of the volatility reduction adjuvant being potassium citrate. Another particularly suitable volatility reduction adjuvant is provided by a mixture of about 65-75% of a 50% solution of potassium acetate with the balance of the volatility reduction adjuvant being potassium citrate. A particularly suitable volatility reduction adjuvant is provided by a mixture of about 73% of a 50% solution of potassium acetate with about 63.5 wt % potassium citrate.

A variety of acid salts may be used, and without limiting the scope of the invention the acid chosen should be of appropriate pKa such that its salt will be appreciably protonated by the acid form of the herbicide(s) being used. For this reason salts of volatile or nonvolatile acids with pKas of approximately 2 and higher, preferably no more than 12, are preferred.

In a particularly suitable method of application a drift reducing and volatility reducing adjuvant would be applied at a rate of 1.25% v/v or less, more preferably 1% v/v or less, while achieving volatility performance equal to a 1% v/v solution of 50% potassium acetate.

The volatility reduction adjuvant is particularly suitable for use with herbicides including dicamba, 2,4-D, and combinations thereof preferably in an aqueous solution. The volatility reduction adjuvant is also particularly suitable for use with mixtures of auxin herbicides such as dicamba and 2,4-D with other herbicides including glyphosate, glufosinate, 4-hydroxyphenylpyruvate dioxygenase (HPPD) inhibitors and protoporphyrinogen oxidase (PPO) inhibitors preferably in an aqueous solution. The use of the volatility reduction adjuvant does not alter the effective concentration of the herbicides thereby allowing the herbicides to be used in accordance with guidance from the manufacturer.

It is preferred that the herbicide formulation, volatility reduction adjuvant and spray formulation comprising both have a pH of about 4-9 and more about preferably 5-7.

The present invention allows for the use of a highly concentrated mix of polyacrylamide, potassium acetate and potassium citrate at a lower use rate to pass the volatility benchmark set by the EPA for tank mixing with commercially available materials such as Xtendimax®. While not limited to theory it is hypothesized that the combination of high concentrations of ionic materials and polyacrylamide in these formulas and the right mix of potassium acetate and citrate provides the synergistic advantage.

### Examples

The tests below were conducted in a humidome study at Mississippi State University in Starkville MS. Humiome studies are known in the art and conducted regularly by numerous organizations. This studies are generally conducted by placing about 1 inch of soil, or other substrate, in the base of a plastic germinating tray, applying a defined rate of herbicide mixture on that substrate, placing a lid on the germinating tray to close it and then placing that germinating tray in a greenhouse for 24 hours at a temperature of at least about 85° F. The lid of the germinating tray has a hole cut into it on one side so that a glass tube containing a polyurethane foam plug, PUF and be inserted into the headspace of the germinating tray. That glass tube is connected to a plastic hose attached to a pump so that air can be pulled from the headspace, across the PUF for the duration of the test. After the test period, in this case 24 hours, the PUFs are removed and herbicide of interest, in this case dicamba, is extracted from the PUF and the quantity of dicamba is measured using HPLC. The amount of dicamba measured on the PUF after 24 hours is considered a represented indicator of the amount of dicamba expected to volatize from a treated field. The lower amount of detected volatile dicamba extracted from the PUF represents lower volatility.

Example 1 The primary spray solution, Treatment 1, contained the two herbicides dicamba (Xtendimax® with Vaporgrip® Technology) and glyphosate (Roundup Powermax II). The treatment samples were representative of a dicamba rate applied of 560 g of active ingredient per hectare (g ae/ha). The glyphosate represents a rate applied of 1260 g ae/ha. The spray volume for the application was based on 15 gallons per acre. To the primary spray solution, Treatment 1, the following were added: Treatment 2-1% v/v of 50% solution of potassium acetate Treatment 3-1.25% v/v of Mixture 1 which contains 36.6% potassium acetate and 12% potassium citrate Treatment 4-1% v/v of Mixture 1 which contains 36.6% potassium acetate and 12% potassium citrate.

For convenience the treatment samples were laboratory tested with Table 1 listing the amount of potassium acetate and potassium citrate added and the amount of dicamba measured in the headspace after 24 hours.

TABLE 1

| | potassium | potassium | total | ng/PUF | % |
|---|---|---|---|---|---|
| | acetate | citrate | buffer | dicamba | reduction |
| Treatment 1 | 0 | 0 | 0 | 2926.27 | 0 |
| Treatment 2 | 0.005 | 0 | 0.005 | 29.15 | 99.00% |
| Treatment 3 | 0.004575 | 0.0015 | 0.0061 | 15.72 | 99.46% |
| Treatment 4 | 0.00366 | 0.0012 | 0.0049 | 23.87 | 99.18% |

In Table 1 ng/PUF indicates the nanograms of dicamba collected on a polyurethane filter.

Table 1 demonstrates the advantages of the invention. A greater % reduction of dicamba is achieved in Treatments 3 and 4 despite lower levels of potassium acetate added to the spray solution. Furthermore, Treatment 4 demonstrates an improvement in the reduction of the volatility relative to Treatment 2. In this example, the total amount of volatility reduction adjuvant added to Treatment 4 is less than the amount of potassium acetate in Treatment 2. The results suggest a synergistic relationship between potassium acetate and potassium citrate for the reduction of dicamba volatility.

Example 2 A series of solutions was prepared to test the volatility of dicamba in humidomes in three distinct tests. All samples comprised sufficient dicamba to represent an application rate of application of 560 g ae/ha and a sufficient amount of Roundup Powermax II to represent an application rate of 1260 g ae/ha. In order to test the effect on volatility reduction from the volatile and non-volatile acids the following mixtures were prepared.

| | 50% K | K | Na | DI |
|---|---|---|---|---|
| Sample | Acetate | citrate | Polyacrylate | water |
| JM19- | 40 | 0 | 0 | 60 |
| 12A | | | | |
| JM19- | 30 | 5 | 0 | 65 |
| 12B | | | | |
| JM19- | 20 | 10 | 0 | 70 |
| 12C | | | | |
| JM19- | 10 | 15 | 0 | 75 |
| 12D | | | | |
| JM19- | 0 | 20 | 0 | 80 |
| 12E | | | | |
| JM19- | 30 | 0 | 0 | 70 |
| 12F | | | | |
| JM19- | 30 | 5 | 0 | 65 |
| 12G | | | | |
| JM19- | 30 | 10 | 0 | 70 |
| 12H | | | | |
| JM19- | 0 | 20 | 0 | 80 |
| 121 | | | | |
| JM19- | 30 | 0 | 5 | 65 |
| 12J | | | | |
| JM19- | 20 | 0 | 10 | 70 |
| 12K | | | | |
| JM19- | 10 | 0 | 15 | 75 |
| 12L | | | | |
| JM19- | 0 | 0 | 20 | 80 |
| 12L | | | | |

The treatment lists for each tests are described in additional detail below. In each test, Treatment 6, contains no additive and represents the baseline volatility level for that specific test. Treatment 1 contains only potassium acetate and treatments 2, 3, 4 and 5 contain blends of potassium acetate and potassium citrate or sodium polyacrylate.

| | Name | Description | Purpose |
|---|---|---|---|
| Test 1 | Treatment | 0.6% ae Clarity + 1.2% ae Roundup | STD |
| | 1 | Powermax 2 + 1% v/v JM19-12A | |
| | Treatment | 0.6% ae Clarity + 1.2% ae Roundup | EXP |
| | 2 | Powermax 2 + 1% v/v JM19-12B | |
| | Treatment | 0.6% ae Clarity + 1.2% ae Roundup | EXP |
| | 3 | Powermax 2 + 1% v/v JM19-12C | |
| | Treatment | 0.6% ae Clarity + 1.2% ae Roundup | EXP |
| | 4 | Powermax 2 + 1% v/v JM19-12D | |
| | Treatment | 0.6% ae Clarity + 1.2% ae Roundup | EXP |
| | 5 | Powermax 2 + 1% v/v JM19-12E | |
| | Treatment | 0.6% ae Clarity + 1.2% ae Roundup | STD |
| | 6 | Powermax 2 | |

| | Name | Description | Purpose |
|---|---|---|---|
| Test 2 | Treatment | 0.6% ae Clarity + 1.2% ae Roundup | STD |
| | 1 | Powermax 2 + 1% v/v JM19-12A | |
| | Treatment | 0.6% ae Clarity + 1.2% ae Roundup | EXP |
| | 2 | Powermax 2 + 1% v/v JM19-12F | |
| | Treatment | 0.6% ae Clarity + 1.2% ae Roundup | EXP |
| | 3 | Powermax 2 + 1% v/v JM19-12G | |
| | Treatment | 0.6% ae Clarity + 1.2% ae Roundup | EXP |
| | 4 | Powermax 2 + 1% v/v JM19-12H | |
| | Treatment | 0.6% ae Clarity + 1.2% ae Roundup | EXP |
| | 5 | Powermax 2 + 1% v/v JM19-12I | |
| | Treatment | 0.6% ae Clarity + 1.2% ae Roundup | STD |
| | 6 | Powermax 2 | |

| | Name | Description | Purpose |
|---|---|---|---|
| Test 3 | Treatment | 0.6% ae Clarity + 1.2% ae Roundup | STD |
| | 1 | Powermax 2 + 1% v/v JM19-12A | |
| | Treatment | 0.6% ae Clarity + 1.2% ae Roundup | EXP |
| | 2 | Powermax 2 + 1% v/v JM19-12J | |
| | Treatment | 0.6% ae Clarity + 1.2% ae Roundup | EXP |
| | 3 | Powermax 2 + 1% v/v JM19-12K | |
| | Treatment | 0.6% ae Clarity + 1.2% ae Roundup | EXP |
| | 4 | Powermax 2 + 1% v/v JM19-12L | |
| | Treatment | 0.6% ae Clarity + 1.2% ae Roundup | EXP |
| | 5 | Powermax 2 + 1% v/v JM19-12M | |
| | Treatment | 0.6% ae Clarity + 1.2% ae Roundup | STD |
| | 6 | Powermax 2 | |

The table below described the data collected from each test. The pH is reported and the amount of volatile dicamba measured after 24 hours of sampling the headspace of each humidome is reported as ng/PUF. The number (Average ng/PUF) reported is the average amount of dicamba measure of three replications for each treatment.

TABLE 2

| Test | Sample | AVG ng/PUF | g KA | g KC | g PA | pH |
|---|---|---|---|---|---|---|
| 1 | 1 | 227.3 | 40 | 0 | 0 | 5.1 |
| 1 | 2 | 315.3 | 30 | 5 | 0 | 5 |
| 1 | 3 | 683.7 | 20 | 10 | 0 | 5 |
| 1 | 4 | 1393.3 | 10 | 15 | 0 | 5 |
| 1 | 5 | 1727.7 | 0 | 20 | 0 | 5.1 |
| 1 | 6 Control | 3233.3 | 0 | 0 | 0 | 4.8 |
| 2 | 1 | 366 | 40 | 0 | 0 | 5.1 |
| 2 | 2 | 691.7 | 30 | 0 | 0 | 5.1 |
| 2 | 3 | 588 | 30 | 5 | 0 | 5.1 |
| 2 | 4 | 637.7 | 30 | 10 | 0 | 5.1 |
| 2 | 5 | 1766.7 | 0 | 20 | 0 | 5 |
| 2 | 6 Control | 2963.3 | 0 | 0 | 0 | 4.8 |
| 3 | 1 | 578.7 | 40 | 0 | 0 | 5.1 |
| 3 | 2 | 735.3 | 30 | 0 | 5 | 5 |
| 3 | 3 | 1054.7 | 20 | 0 | 10 | 5.1 |
| 3 | 4 | 1198 | 10 | 0 | 15 | 5 |
| 3 | 5 | 1550 | 0 | 0 | 20 | 5 |
| 3 | 6 Control | 2516.7 | 0 | 0 | 0 | 4.8 |

In all treatments containing an additive the amount of volatile dicamba detected was less than in the treatment 6 indicating that all additives lowered volatility somewhat. The following table summarizes the % reduction in the amount of volatile dicamba detected for each mixture relative to the treatment 6 control.

| | | volatile | |
|---|---|---|---|
| | | dicamba | % reduction |
| | | detected | in volatile |
| | sample | (ng/PUF) | dicamba |
| Test 1 | Treatment 6 | 3233.3 | 0 |
| | control | | |
| | Treatment 1 | 227.3 | −92.97003062 |
| | Treatment 2 | 315.3 | −90.24835308 |
| | Treatment 3 | 683.7 | −78.85442118 |
| | Treatment 4 | 1393.3 | −56.90780317 |
| | Treatment 5 | 1727.7 | −46.56542851 |
| Test 2 | Treatment 6 | 2963.3 | 0 |
| | control | | |
| | Treatment 1 | 366 | −87.64890494 |
| | Treatment 2 | 691.7 | −76.65778018 |
| | Treatment 3 | 588 | −80.15725711 |
| | Treatment 4 | 637.7 | −78.48007289 |
| | Treatment 5 | 1766.7 | −40.3806567 |
| Test 3 | Treatment 6 | 2516.7 | 0 |
| | control | | |
| | Treatment 1 | 578.7 | −77.00560257 |
| | Treatment 2 | 735.3 | −70.78316843 |
| | Treatment 3 | 1054.7 | −58.0919458 |
| | Treatment 4 | 1198 | −52.39798148 |
| | Treatment 5 | 1550 | −38.41141177 |

Appling the Colby equation for synergy by comparing the % reductions for each demonstrates that the percent reduction for each combination of potassium acetate with potassium citrate and potassium acetate with sodium polyacrylate demonstrates that the measured % reduction for each was greater than the expected percent reduction. To determine the expected % reduction the following equation was used: E=x*y/100 where x=the % reduction from the salt of the volatile acid, in this case potassium acetate and y=the percent reduction expected from the salt of the non-volatile acid, in this case either potassium citrate or sodium polyacrylate, In test 1 the expected % reduction from a blend of the test materials was 43.29%. In test 2 the expected % reduction from a blend of the test materials was 35.39%. In test 3 the expected reduction from a blend of the test materials was 29.58%. Because the % reduction in volatility observed in the tests was greater than the % reduction expected per the equation it can be determined that the combinations of salts from volatile acids and salts from non-volatile acids were discovered to be unexpectedly more effective at reducing the volatility of dicamba.

The advantages provided by the invention are demonstrated in Table 3. One key aspect of the invention as described in Table 3 is the reduction in volatility without any significant change to the tank mix pH which provides further support for a synergistic relationship between the test materials. This synergy can be further described by investigating the % reduction in dicamba detected in the headspace of the humidome.

The invention has been described with reference to preferred embodiments without limit thereto. One of skill in the art would realize additional embodiments which are described and set forth in the claims appended hereto.

1-23. (canceled)

24. A method for treating a crop comprising:
forming a spray formulation by combining a herbicide formulation with a volatility reduction adjuvant comprising:
a salt of a volatile acid; and
a salt of a nonvolatile acid.

25. The method for treating a crop of claim 24 comprising applying said spray formulation at a rate of no more than 1.25% v/v.

26. The method for treating a crop of claim 25 comprising applying said spray formulation at a rate of no more than 1% v/v.

27. The method for treating a crop of claim 24 wherein said volatile acid has a vapor pressure of at least 1 mm Hg at 20° C.

28. The method for treating a crop of claim 24 wherein said salt of said volatile acid is a salt of an acid selected from the group consisting of formic acid, carbonic acid, acetic acid, lactic acid, propionic acid, butyric acid, valeric acid and caproic acid.

29. The method for treating a crop of claim 28 wherein said salt of said volatile acid is selected from the group consisting of lithium formate, sodium formate, potassium formate, mono, di, or triethanolammonium formate, lithium carbonate, sodium carbonate, potassium carbonate, mono, di, or triethanolammonium carbonate, lithium bicarbonate, sodium bicarbonate, potassium bicarbonate, mono, di, or triethanolammonium bicarbonate, lithium acetate, sodium acetate, potassium acetate, mono, di, or triethanolammonium acetate, lithium lactate, sodium lactate, potassium lactate, choline lactate, mono, di, or triethanolammonium lactate, lithium propionate, sodium propionate, potassium propionate, mono, di, or triethanolammonium propionate, lithium butyrate, sodium butyrate, potassium butyrate, mono, di, or triethanolammonium butyrate, lithium valerate, sodium valerate, potassium valerate, mono, di, or triethanolammonium valerate, lithium caprylate, sodium caprylate, potassium caprylate and mono, di, or triethanolammonium caprylate.

30. The method for treating a crop of claim 29 wherein said salt of said volatile acid is selected from the group consisting of lithium acetate, sodium acetate, potassium acetate and mono, di, or triethanolammonium acetate.

31. The method for treating a crop of claim 24 wherein said salt of said volatile acid is selected from the group consisting of a lithium salt, a sodium salt, a potassium salt, a calcium salt, a magnesium salt, a choline salt, and an mono, di, or triethanolammonium or other amine salt.

32. The method for treating a crop of claim 24 wherein said nonvolatile acid has a vapor pressure below 0.1 mm Hg at 20° C.

33. The method for treating a crop of claim 24 wherein said nonvolatile acid is selected from the group consisting of a lithium salt, a sodium salt, a potassium salt, a calcium salt, a magnesium salt, a choline salt, and an mono, di, or triethanolammonium or other amine salt.

34. The method for treating a crop of claim 24 wherein said salt of a nonvolatile acid is a salt of an acid selected from the group consisting of a polycarboxylic acid, a phosphate, a gluconic acid, a sulfate, a citrate, a borate, a carbonate, a tartrate, a glutamate, an oxalate, a polyacrylate and a polymethacrylate.

35. The method for treating a crop of claim 34 wherein said salt of a nonvolatile acid is a salt of a dicarboxylic acid or a tricarboxylic acids.

36. The method for treating a crop of claim 24 wherein said salt of a nonvolatile acid is a salt of a phosphate, a gluconate, an oxalate, a succinate, a citrate, a polymethacrylate, a polyacrylate, a polyphosphate or a polycarbonate.

37. The method for treating a crop of claim 24 wherein said salt of a nonvolatile acid is a salt of an acid selected from the group consisting of oxalic acid, malonic acid, malic acid, succinic acid, citric acid, maleic acid and tartaric acid.

38. The method for treating a crop of claim 37 wherein said salt of a nonvolatile acid is selected from the group consisting of lithium oxalate, sodium oxalate, potassium oxalate, mono, di, or triethanolammonium oxalate, lithium malonate, sodium malonate, potassium malonate, mono, di, or triethanolammonium malonate, lithium malate, sodium malate, potassium malate, mono, di, or triethanolammonium malate, lithium succinate, sodium succinate, potassium succinate, mono, di, or triethanolammonium succinate, lithium citrate, sodium citrate, potassium citrate, mono, di, or triethanolammonium citrate, lithium maleate, sodium maleate, potassium maleate, mono, di, or triethanolammonium maleate, lithium tartarate, sodium tartarate, potassium tartarate and mono, di, or triethanolammonium tartarate.

39. The method for treating a crop of claim 38 wherein said salt of a nonvolatile acid is selected from the group consisting of lithium citrate, sodium citrate, potassium citrate and mono, di, or triethanolammonium citrate.

40. The method for treating a crop of claim 24 wherein said nonvolatile acid is an acetate salt and said nonvolatile acid is a polycarboxylate salt.

41. The method for treating a crop of claim 24 wherein said volatility reduction adjuvant comprises potassium acetate and potassium citrate.

42. The method for treating a crop of claim 24 wherein said salt of said volatile acid and said salt of said nonvolatile acid are in a weight ratio of between about 10:1 and 1:1.

43. The method for treating a crop of claim 42 wherein said weight ratio is between 5:1 and 2:1.

44. The method for treating a crop of claim 24 wherein said spray formulation has a pH between about 4 and about 9.

45. The method for treating a crop of claim 44 wherein said pH is between about 5 and about 7.

46. The method for treating a crop of claim 24 wherein said herbicide is at least one of an auxin, dicamba or 2,4-D.

47. The method for treating a crop of claim 46 wherein said herbicide comprises an auxin and at least one of glyphosate and glufosinate.

48. The method for treating a crop of claim 24 further comprising polyacrylamide, guar gum, xanthan gum, or other drift control polymers.
